(19) United States
(12) Patent Application Publication
(10) Pub. No.: US 2025/0106035 A1
(43) Pub. Date: Mar. 27, 2025

(54) CONFIGURATION VERIFICATION USING VARIABLE INPUTS AND HASH FUNCTIONS

(71) Applicant: Microsoft Technology Licensing, LLC, Redmond, WA (US)

(72) Inventors: John P. FALCONE, Kirkland, WA (US); Daniel J. Oliver, Seattle, WA (US); Michael J. NOVAK, Redmond, WA (US)

(73) Assignee: Microsoft Technology Licensing, LLC, Redmond, WA (US)

(21) Appl. No.: 18/476,038

(22) Filed: Sep. 27, 2023

(51) Int. Cl. H04L 9/32

(52) U.S. Cl. CPC H04L 9/3236

(57) ABSTRACT

Systems and methods for configuration verification using variable inputs and hash functions are disclosed. A computing device may receive, via an operating system user interface, configuration data associated with a configuration setting of the computing device. In response to receiving the configuration data, the computing device may store the configuration data and obtain, based on a hash configuration, a set of inputs and a hash function. The computing device may hash, using the hash function, the set of inputs in an input order indicated by the hash configuration to generate a first verification code based on the configuration data. The computing device may subsequently verify stored configuration data by generating a second verification code based on the stored configuration data and comparing the second verification code to the first verification code.

### BACKGROUND

An operating system for a computing device can maintain configuration information for various aspects of the computing device's behavior, such as how the computing device displays information and which application the computing device launches when a user requests to open a particular file type, among other configuration settings. A user can enter configuration information in a user interface associated with the operating system to customize the configuration settings in accordance with their preferences. In some cases, an application other than the operating system can provide a user interface to enable the user to change the configuration information, or an application can change the configuration information directly.

It is with respect to these and other considerations that examples are presented herein. In addition, although relatively specific problems have been discussed, it should be understood that the examples should not be limited to solving the specific problems identified in the background.

### SUMMARY

Examples described in this disclosure relate to systems and methods for configuration verification using variable inputs and hash functions. In one example, in response to receiving a request to update a configuration setting including first configuration data, a computing device generates, based on a hash configuration, a verification code associated with the request to update the configuration setting. The hash configuration includes an indication of a set of input types, an indication of an input order, and/or an indication of a hash function. In some examples, the computing device generates the verification code by hashing a set of inputs that are selected based on the hash configuration in an input order that is specified by the hash configuration. In some examples, the computing device identifies, based on the hash configuration, a first set of inputs, a first input order, and a first hashing function with which to generate a verification code by hashing the first set of inputs in the first input order using the first hashing function. The computing device may receive an updated hash configuration after generating a verification code. In response to receiving a second request to update the configuration setting after receiving the updated hash configuration, the computing device identifies, based on the updated hash configuration, a second set of inputs, a second input order, and/or a second hash function with which to generate a second verification code, where the second set of inputs is different from the first set of inputs, the second input order is different from the first input order, and/or the second hash function is different from the first hash function. The computing device generates a second verification code by hashing the second set of inputs in the second input order using the second hash function and stores the second verification code.

The verification codes may then be used to verify or otherwise determine if a user choice for a configuration setting has been changed or overwritten, such as by another application. For instance, when the configuration setting is used or invoked, the inputs can be rehashed to generate a new verification code that is compared to the stored verification code. If the codes do not match, the configuration setting may have been changed or overwritten by a source other than the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present disclosure is illustrated by way of example by the accompanying figures, in which like references indicate similar elements. Elements in the figures are illustrated for simplicity and clarity and have not necessarily been drawn to scale.

FIGS. 1A-1B depict user interfaces for changing a configuration setting in accordance with some examples;

FIG. 2A depicts a hash configuration in accordance with some examples;

FIG. 2B depicts a data flow for generating a verification code based on a hash configuration in accordance with some examples;

FIG. 3 depicts data paths for generating a verification code for configuration verification using variable inputs and hash functions in accordance with some examples;

FIGS. 4A-4B depict a flowchart of an example method for configuration verification using variable inputs and hash functions in accordance with some examples;

FIG. 5 depicts a flowchart of an example method for configuration verification using variable inputs and hash functions in accordance with some examples;

FIG. 6 depicts a flowchart of an example method for configuration verification using variable inputs and hash functions in accordance with some examples;

FIG. 7 is a block diagram illustrating example physical components of a computing device with which aspects of the disclosure may be practiced; and

FIG. 8 is a block diagram illustrating example physical components of a computing device with which aspects of the disclosure may be practiced.

### DETAILED DESCRIPTION

Examples described in this disclosure relate to systems and methods for configuration verification using variable inputs and hash functions. An operating system (OS) for a computing device can maintain configuration information (e.g., configuration data) that specifies various user configuration settings associated with the computing device and/or with a user of the computing device. For example, the configuration information can specify how the OS of the computing device displays information (e.g., a visual appearance and/or a location of information on a display screen), which application the OS of the computing device launches when a user requests to open a particular file type (e.g., a default application associated with a file extension, such as .pdf, .jpg, etc.), a default web browser, and/or selectable application icons to display within a predetermined region on the display screen (e.g., a ribbon, task bar, or other predefined area in which application icons are displayed), an application to launch when a link containing a particular uniform resource identifier (URI) scheme (e.g., http, https, mailto) is selected, among other configuration settings. In some examples, a user can update these configuration settings via a user interface associated with the OS. In some examples, an application or service other than the OS can present a user interface or a prompt to encourage the user to change the configuration settings via the application or service user interface rather than via the user interface associated with the OS (e.g., to encourage the user to select the currently active application or service as a default application or service, for example).

Such non-OS user interfaces for changing a configuration setting may be unclear or misleading, or may make it difficult for the user to avoid selecting a setting suggested by the user interface. Thus, in some cases, a user may (inadvertently or otherwise) change a configuration setting to a setting that does not represent the user's preferences. For example, a user may select a different default search engine than desired or a different default application than desired. In some cases, an application or service may update a configuration setting in the background, without a user's explicit selection of the configuration setting and/or without the user's knowledge. Thus, it may be desirable to discourage application developers from providing user interfaces for changing configuration settings outside of an OS user interface and from changing configuration settings directly (e.g., without explicit user input).

To help address the above issues, the technology disclosed herein provides for methods and systems that more robustly protect and verify the choices actually made by the user for configuration settings. For instance, when an OS receives updated configuration data via an OS user interface, the OS hashes the configuration data (optionally, along with other inputs, such as a predetermined character string) using a hash function to generate a first verification code. The hash function receives an input and generates an encoded output that cannot be reversed (e.g., cannot be unencoded) to determine the input. In some examples, a hash function maps a bit string of arbitrary length (e.g., configuration data and optionally other inputs) to a fixed-length bit string (e.g., a verification code).

In addition to storing the verification code, the OS also stores the un-hashed configuration data such that it can subsequently be accessed by the OS to determine appropriate configuration settings. For example, the OS may access the un-hashed configuration data when a user selects a file to open (e.g., to determine which application to launch), when the computing device is rebooted (e.g., to determine which application icons to display in a ribbon), or at any other time when the OS needs to determine a configuration setting. In some examples, when the OS accesses the un-hashed configuration data to determine a configuration setting, the OS verifies the un-hashed configuration data by re-hashing the configuration data (along with any other inputs used to generate the first verification code) to generate a second verification code. The OS compares the second verification code to the first verification code to confirm that the un-hashed configuration data has not been changed outside of the OS user interface.

If the OS determines that the second verification code matches the first verification code, the OS applies (e.g., uses) the stored configuration data. If the OS determines that the second verification code does not match the first verification code, the OS may not apply (e.g., may not use) the stored configuration data. Instead, in some examples, the OS resets the configuration data to default configuration data (e.g., configuration data initially supplied with the OS or other default configuration data) and applies the default configuration data rather than the stored configuration data. In some examples, when the OS resets the configuration data to the default configuration data, the OS replaces the stored configuration data with the default configuration data and generates a verification code corresponding to the default configuration data. If the OS updates the stored configuration data, an alert or other user interface indicator may also be surfaced (e.g., by the OS) to notify the user of the change to the data, and in some examples, the OS displays an OS user interface to allow the user to change the respective configuration setting. In some examples, if the OS determines that the second verification code does not match the first verification code, the OS applies the stored configuration data and issues an alert to the user that the stored configuration data has been changed.

The above-described techniques can help reduce the likelihood that configuration settings are changed outside of the context of an OS user interface. However, it may be possible for the hash function and/or the predetermined character string used to generate the verification code to be identified or reverse-engineered by third-party vendors (e.g., application developers or other entities that are not associated with a vendor of the OS), thereby enabling such vendors to generate valid verification codes outside of the OS and circumvent the verification process. As described herein, using variable inputs and hash functions for configuration verification can reduce the likelihood that third-party vendors can generate valid verification codes.

With the technology disclosed herein, a computing device uses varying inputs, varying input orders, and/or varying hash functions to generate verification codes such that different inputs, different input orders, and/or different hash functions are used by the computing device at different times, thereby decreasing the likelihood that a valid verification code can be produced outside of the OS. In some examples, a computing device receives a hash configuration that includes an indication of input types (e.g., the types of inputs to use for the hash function), an indication of an input order (e.g., an order in which the inputs should be provided to the hash function), and/or an indication of a hash function. The computing device identifies, based on the hash configuration, a set of inputs and a hash function, and hashes the set of inputs in the indicated input order using the hash function to generate a verification code. In some examples, the hash configuration is received by the computing device from an external device. For instance, the hash configuration may be received within an OS update (e.g., as part of the update) or in another communication.

In some examples, an OS vendor provides different hash configurations to different computing devices. The OS vendor may select a hash configuration for a computing device based on a property of the computing device, such as based on some or all of a serial number of the computing device, based on a geographic location of a computing device, and/or based on another property of the computing device. For example, computing devices whose serial numbers have the same final three digits may receive, from the computing system, a first hash configuration, while computing devices whose serial numbers have a different final three digits may receive a different hash configuration. In this manner, different computing devices using the same OS can generate different verification codes for the same configuration data. By sending different hash configurations to different computing devices (and optionally, regularly updating the hash configurations) an OS vendor can increase the difficulty of generating valid verification codes outside of the OS.

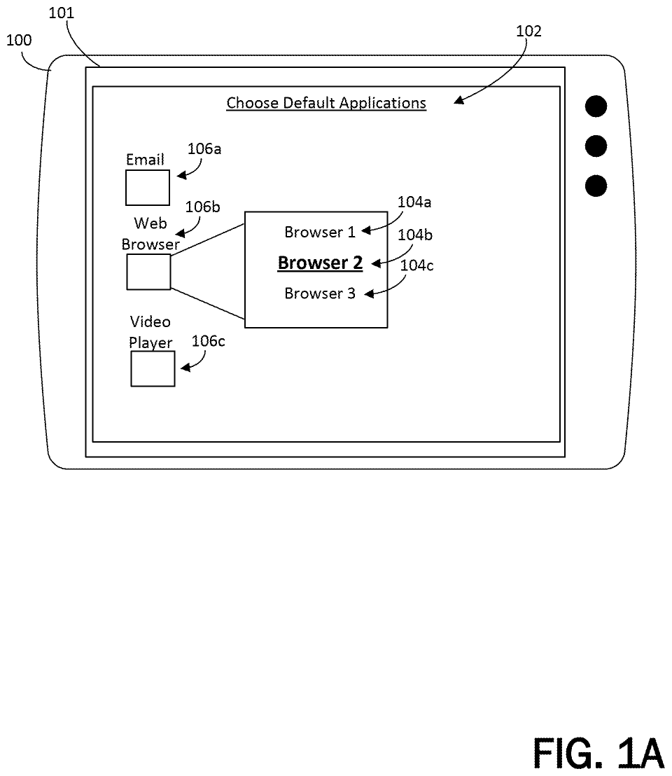

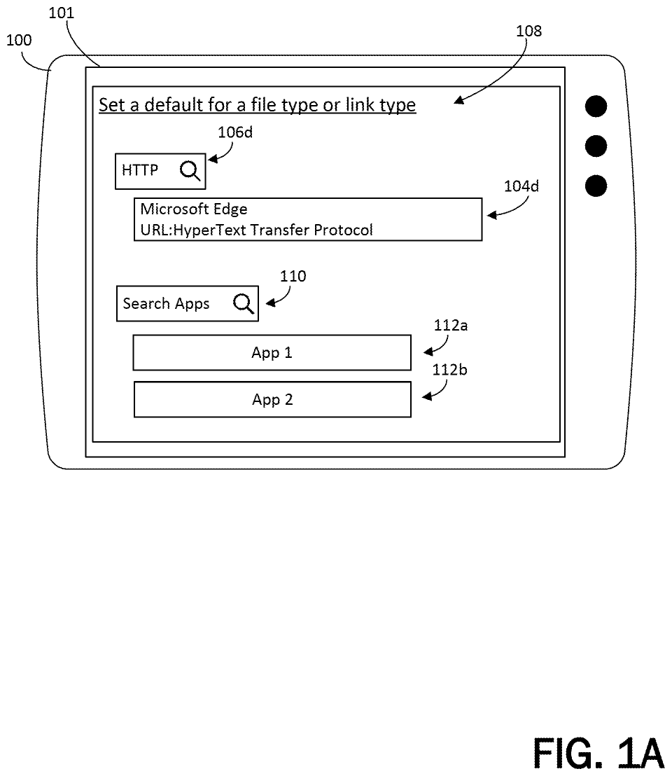

Additional details regarding systems and methods for configuration verification using variable inputs and hash functions are described with reference to FIGS. 1A-5, including an illustrative example described with reference to FIGS. 1A-3.

FIG. 1A depicts an example user interface 102 for updating a configuration setting (e.g., an OS configuration setting). In some examples, the user interface 102 is displayed on a display 101 associated with a computing device 100. In some examples, the user interface 102 is an OS user interface that is output by an OS of the computing device 100 (e.g., the OS includes instructions that cause the computing device 100 to display user interface 102 in response to a user input associated with changing a configuration setting of the computing device).

In the example of FIG. 1A, the user interface 102 allows a user to update a configuration setting (e.g., to enter a particular value) for three configuration items 106 (e.g., three user-configurable aspects of the computing device): a default email application 106a (e.g., a particular email application that should be launched when a user selects an email icon or attempts to open a file with an e-mail related file extension), a default web browser application 106b (e.g., a particular web browser that should be launched when a user selects a web browser icon or attempts to open a file with a browser-related file extension), and a default video player 106c (e.g., a particular video player application that should be launched when a user selects a video player icon or attempts to open a file with a video-related file extension). In some examples, an input can be received to select or enter configuration data 104 (e.g., first configuration data 104a, second configuration data 104b, or third configuration data 104c) associated with a configuration item (e.g., to change the configuration setting). In the example of FIG. 1A, the user has selected, in the user interface 102, second configuration data 104b (“Browser 2”) for the default web browser. In response to detecting a request to change a configuration setting (e.g., in response to detecting that the user has selected or entered new configuration data that is different from the current configuration data associated with the configuration setting) via a user interface 102, the computing device 100 (e.g., an OS of the computing device 100) stores the new configuration data (e.g., in a database on the computing device 100 that stores configuration information for the computing device) and generates and stores a verification code associated with the new configuration data. The computing device 100 generates the verification code by hashing a set of inputs based on a hash configuration stored on the computing device. In some examples, the configuration data stored by the computing device and used to generate the verification code is represented by the text shown for the configuration data 104 in FIG. 1A but does not necessarily include that text.

In the example of user interface 102, the user can select configuration settings based on categories of applications (e.g., email, web browser, video player), where each category may be associated with one or more file types. In other user interfaces, the user can select configuration settings based on specific file types (e.g., .txt, .jpg) and/or link types (e.g., URI schemes) to configure the OS to launch the selected application when a file of the specified file type or a link of the specified link type is selected, such as shown in FIG. 1B.

FIG. 1B depicts another example user interface 108 for updating a configuration setting of an OS of a computing device 100. In some examples, the user interface 108 is displayed on a display 101 associated with a computing device 100. In some examples, the user interface 108 is an OS user interface that is output by an OS of the computing device 100 (e.g., the OS includes instructions that cause the computing device 100 to display user interface 108 in response to a user input associated with changing a configuration setting of the computing device). User interface 108 allows a user to update a configuration setting (e.g., to select a particular application) for a selected file type or link type (e.g., for a selected configuration item) such that the OS launches the selected application when a file of the selected file type is accessed, or a link of the selected link type is accessed.

In the example of FIG. 1B, the user has selected configuration item 106d corresponding to the link type of HTTP and has selected configuration data 104d (represented by the text “Microsoft Edge URL: HyperText Transfer Protocol”) as the configuration setting for configuration item 106d. In some examples, the user can select different configuration data by selecting a different application to associate with configuration item 106d (e.g., a first application 112a, a second application 112b, or another application). In some examples, a user can search for applications using a search icon 110. As described with reference to FIG. 1A, in response to detecting a request to change a configuration setting (e.g., in response to detecting that the user has selected or entered new configuration data that is different from the current configuration data associated with the configuration setting) via a user interface 108, the computing device 100 stores the new configuration data (e.g., in a database on the computing device that stores configuration information for the computing device) and generates and stores a verification code associated with the new configuration data.

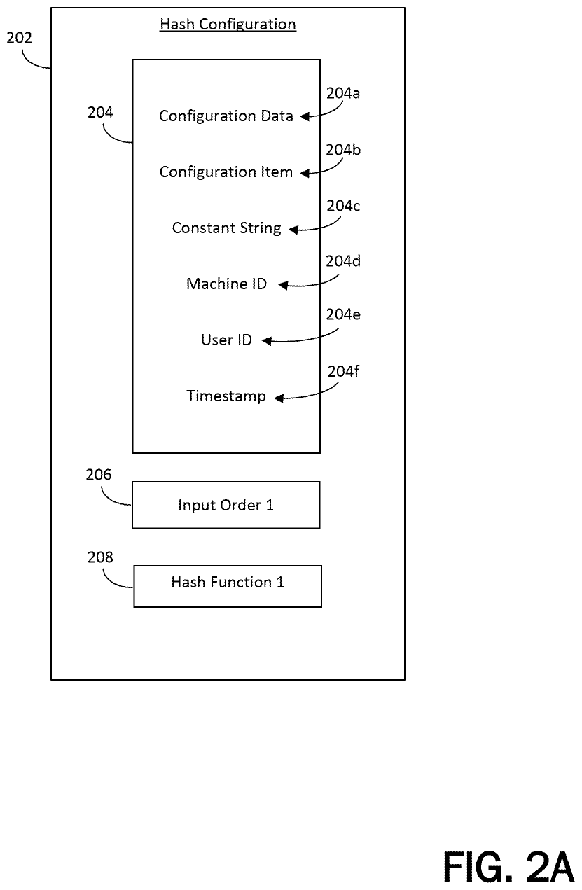

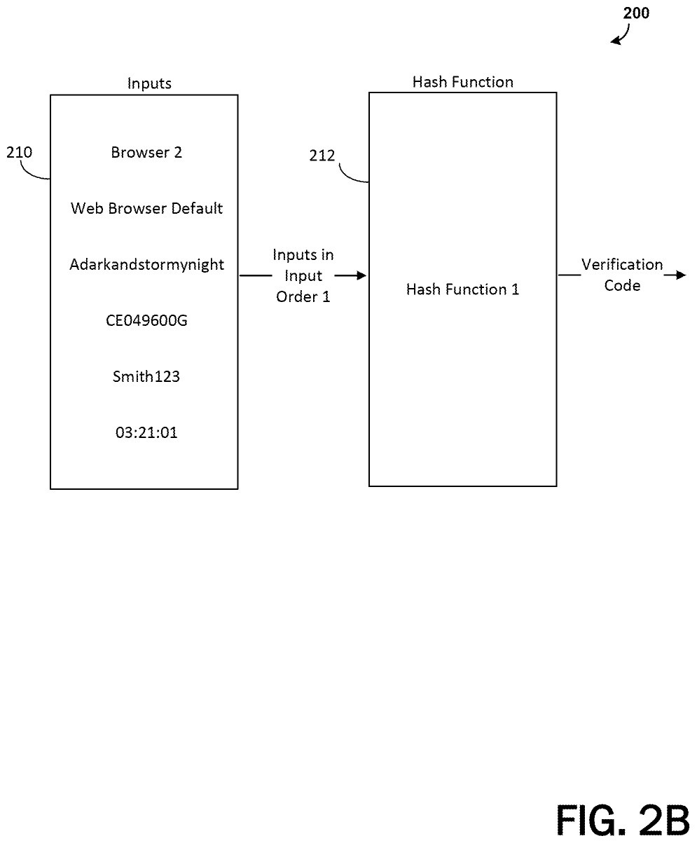

FIG. 2A depicts an example of a hash configuration 202 that includes an indication of a set of input types 204 (e.g., including input types 204a-204f), an indication of an input order 206, and an indication of a hash function 208. The indication of the set of input types 204 indicates the types of inputs that will be used to generate the verification code. The indication of the input order 206 indicates the order in which the inputs should be hashed (e.g., input order 1). The indication of the hash function 208 indicates a particular hash function that should be used to hash the inputs to generate the verification code (e.g., hash function 1). In some examples, a hash configuration includes a subset of these indications rather than all of the indications. For example, a hash configuration can include an indication of a hash function and not include (e.g., exclude) an indication of a set of input types and/or an indication of an input order. Any other combination of one or more of these indications may also or alternatively be used.

In the example of FIG. 2A, the indication of the set of input types 204 indicates that the following input types will be used for generating the verification code:
A configuration data input type 204a (e.g., corresponding to a particular value that has been selected for a configuration setting)
A configuration item input type 204b (e.g., corresponding to a particular configuration item that is affected by the configuration setting);
A constant string input type 204c (e.g., corresponding to a predetermined string of characters that is stored on or received by the computing device, which may include a globally unique identifier (GUID));
A machine identifier input type 204d (e.g., corresponding to an identifier associated with the computing device, such as some or all of a serial number of the computing device, some or all of a version number associated with an OS of the computing device, or another identifier)
A user identifier input type 204e (e.g., corresponding to an identifier associated with a user of the computing device, such as a user name or security identifier (SID), which may be unique to the user)
A timestamp input type 204f (e.g., corresponding to a timestamp associated with the request to update the configuration setting, such as a time at which the request was received or a time at which the updated configuration data was stored)

Although FIG. 2A depicts a specific set of six input types, it should be understood that a different set of input types and/or a different quantity of input types can be used without departing from the scope of the disclosure.

In some examples, the computing device identifies (e.g., selects, obtains, retrieves), based on the indication of the set of input types 204, a set of inputs (e.g., values) corresponding to the set of input types 204, such as described with reference to FIG. 2B.

FIG. 2B depicts a data flow for generating a verification code based on the user input depicted in FIG. 1A and the hash configuration 202 depicted in FIG. 2A. In response to detecting the request to change the configuration setting as shown in FIG. 1A and based on the hash configuration 202 of FIG. 2A, the computing device identifies “Browser 2” as an input corresponding to the configuration data input type 204a (e.g., the value selected by the user in user interface 102), “Web Browser Default” (or “http” in some examples) as an input corresponding to the configuration item input type 204b (e.g., the item whose value is being changed), constant string “Adarkandstormynight” corresponding to the constant string input type 204c (e.g., the predetermined string of characters obtained by the computing device, which in some examples is selected by the computing device from a set of predetermined strings based on the hash configuration and/or based on another input obtained by the computing device, such as a machine identifier of the computing device), “CE049600G” as an input corresponding to the machine identifier input type 204d (e.g., a serial number of the computing device), “Smith123” corresponding to the user identifier input type 204e (e.g., a user name of a user associated with the computing device), and “03:21:01” corresponding to the timestamp input type 204f (e.g., a timestamp associated with the request to change the configuration setting for the default web browser, such as a time at which the request was received or a time at which the configuration data was stored). In other examples, the timestamp may further indicate the date and time as which the configuration setting was changed (e.g., 2023-08-31T19:21:03).

In some examples, the computing device identifies, based on the indication of the hash function 208 in the hash configuration 202, a hash function 212 to use for hashing the set of inputs 210. The indication of the hash function 208 in the hash configuration 202 may include the hash function 212 itself, in which case the computing device identifies the hash function 208 by retrieving the hash function 212 from the hash configuration 202. In other examples, the indication of the hash function 208 in the hash configuration 202 includes an index or pointer associated with the hash function 212, and the computing device identifies the hash function 208 by selecting the hash function 212 from a plurality of hash functions (e.g., a plurality of hash functions stored on the computing device or accessed by the computing device) based on the index.

As shown in FIG. 2B the computing device generates a verification code by hashing the set of inputs 210 using the hash function 208. In some examples, the computing device hashes the set of inputs 210 in an input order that is determined by the computing device based on the hash configuration 202 (e.g., based on the indication of the input order 206). In some examples, the indication of the input order 206 is explicit; e.g., it is separate from the indication of the set of input types 204. In other examples, the indication of the input order 206 is implicit in the order of the input types in the set of input types 204; e.g., the computing device hashes the set of inputs 210 in an input order corresponding to the order of the set of input types 204.

In some examples, the stored verification code can subsequently be used to verify stored configuration data. For example, an OS of a computing device may retrieve stored configuration data in response to detecting an event that is associated with a user configuration setting (e.g., an event that requires access to the configuration data associated with the user configuration setting), such as in response to a request to open a file, an application being launched, the computing device being rebooted, or at other times. In some examples, in response to detecting such an event, the computing device retrieves the stored configuration data and generates a new verification code based on the current hash configuration (e.g., the most recently received hash configuration) and the stored configuration data. The computing device compares the new verification code with the stored verification code (e.g., a previously generated verification code, such as a verification code that was generated when the configuration data was last updated in the OS user interface) to determine whether the new verification code matches the stored verification code. Such a comparison allows for the determination of whether the stored (un-hashed) configuration data was stored via the OS user interface or was stored via a different application. For instance, if the new verification code matches the stored verification code, the computing device applies the stored configuration data. If the new verification code does not match the stored verification code, the computing device may not apply the stored configuration data, and instead may apply default configuration data.

The computing device may also store an un-hashed timestamp with the configuration data such that the timestamp can be retrieved with the configuration data. In some examples, the timestamp stored with the configuration data is the same timestamp as used in the set of inputs. For example, in FIG. 2B, the computing device may store an un-hashed copy of timestamp “03:21:01” with the configuration data and use the same timestamp to generate the verification code. When verifying stored configuration data, the computing device retrieves the stored configuration data and the associated timestamp and uses the stored configuration data and timestamp to generate a verification code that can be compared with the stored verification code to determine whether the stored configuration data is valid. Storing a timestamp with the configuration data and using it to generate the verification code can help prevent replay attacks that attempt to intercept a valid verification code and re-store it later in conjunction with updating the configuration data (such as to restore a particular application as a default application, for example). In such types of replay attacks, the timestamp associated with the configuration data will not match the timestamp used to generate the intercepted verification code (since the verification code was generated at a different time), and therefore the verification code will be determined to be invalid.

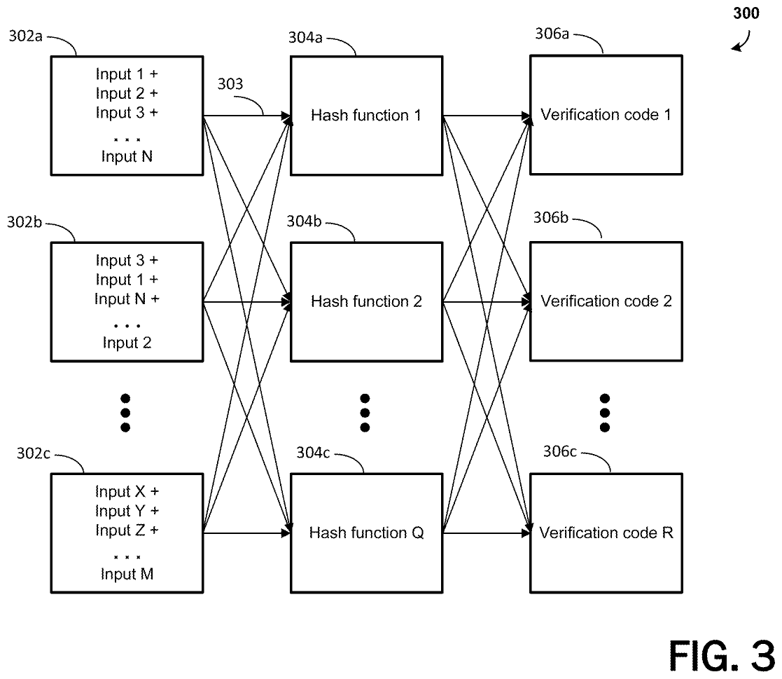

FIGS. 1-2B depict an example of using a particular set of inputs, a particular input order, and a particular hash function (one or more of which may be specified in hash configuration) to generate a verification code. As previously discussed, each of these items can be dynamically changed based on an updated hash configuration to reduce the likelihood of third-party vendors generating valid verification codes, as illustrated in FIG. 3.

FIG. 3 depicts example data paths for configuration verification using variable inputs and hash functions. In FIG. 3, each of the directional lines 303 represents a data path that can be traversed to generate a verification code based on a particular hash configuration that specifies a set of input types, an input order, and/or a hash function. For example, a computing device can obtain, based on an indication of a set of input types and an indication of an input order, a set of ordered inputs 302 such as a first set of ordered inputs 302a (e.g., a first set of N inputs organized in a first order), a second set of ordered inputs 302b (e.g., the first set of N inputs organized in a second order), a third set of ordered inputs 302c (e.g., a third set of M inputs organized in a third order), or another set of ordered inputs. As depicted in FIG. 3, the quantity of inputs, the types of inputs, and the input order can each vary based on the hash configuration. After obtaining the set of ordered inputs 302 (e.g., by obtaining a set of inputs corresponding to an indicated set of input types and organizing the set of inputs in the selected input order), the computing device can obtain, based on an indication of a hash function, a hash function 304 with which to hash the set of ordered inputs 302. For example, the computing device can obtain a first hash function 304a, a second hash function 304b, a third hash function 304c, or a different hash function. In some examples, the computing device hashes the set of ordered inputs 302 using the hash function 304 to generate a verification code 306. For example, depending on the set of ordered inputs 302 and the hash function 304, the computing device can generate a first verification code 306a, a second verification code 306b, a third verification code 306c, or another verification code.

In some examples, in response to receiving an updated hash configuration, the computing device re-generates the verification code using the updated hash configuration. For example, after generating a first verification code based on a first hash configuration and first configuration data, the computing device receives a second (different) hash configuration. In some examples, the second hash configuration includes an indication of a second set of input types, an indication of a second input order, and/or an indication of a second hash function (but for the same configuration setting). In some examples, in response to receiving the second hash configuration, the computing device re-hashes, based on the second hash configuration, the currently stored (un-hashed) configuration data using a second set of inputs (e.g., corresponding to the second set of input types), the second input order, and/or the second hash function to generate a second verification code associated with the configuration data. Before generating the updated verification code using the second hash configuration, the computing device may verify the currently stored (un-hashed) configuration data and corresponding timestamp using the first hash configuration, the stored verification code, and the stored timestamp, as described previously. In this manner, the computing device confirms that the currently stored configuration data and corresponding timestamp match the verification code (e.g., are valid) before generating an updated verification code using the second hash configuration.

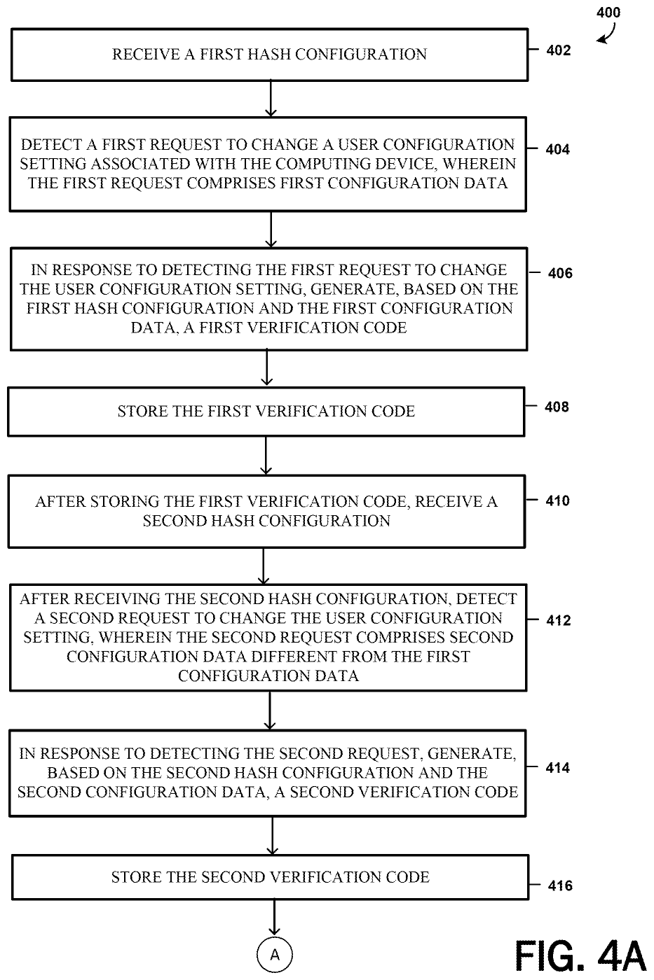

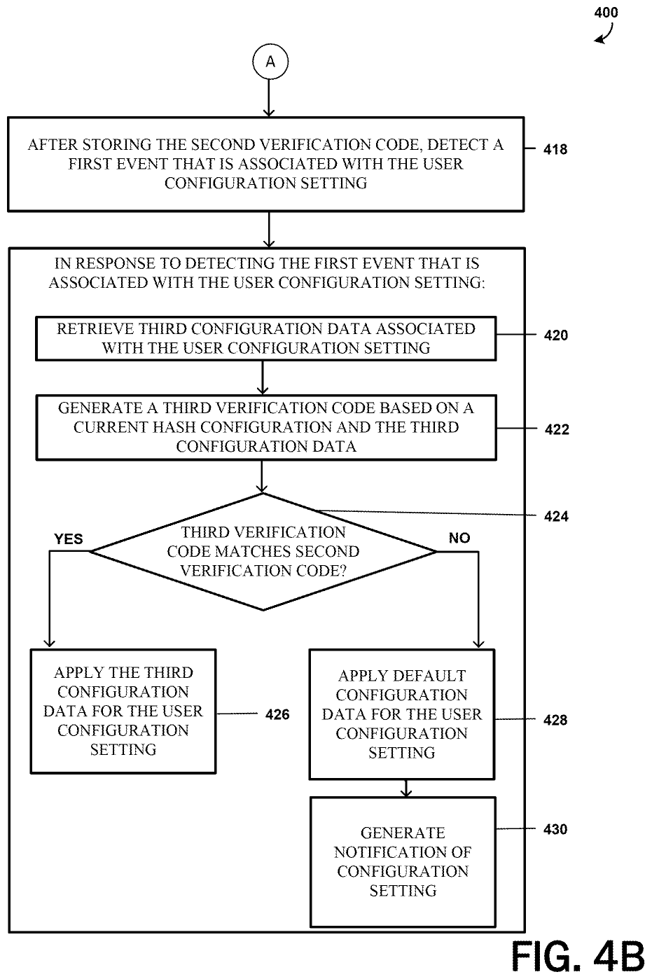

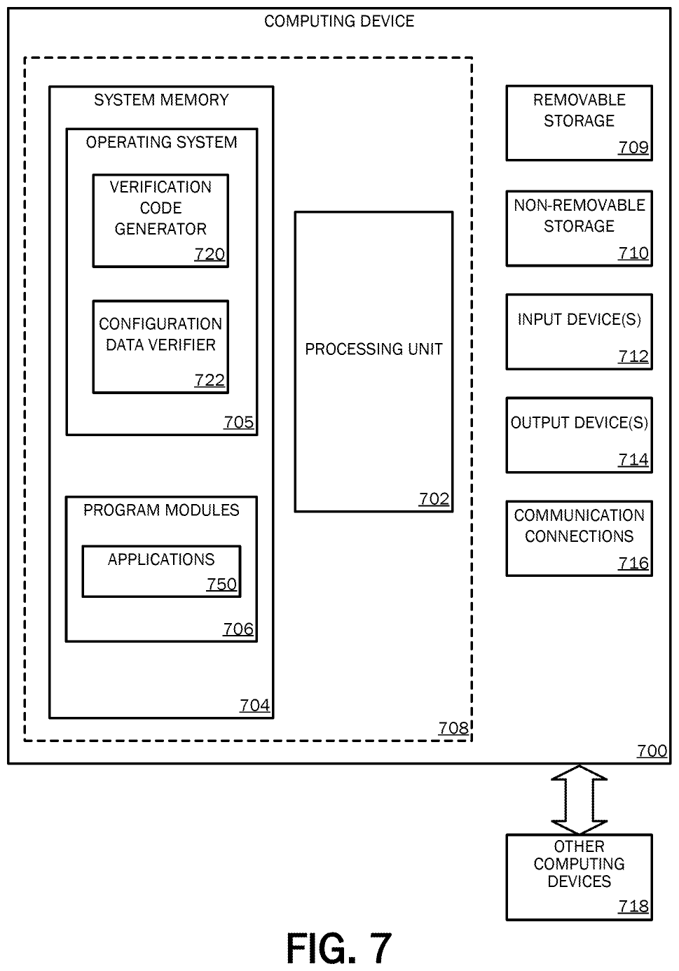

FIGS. 4A-4B depict a flowchart of a method 400 for configuration verification using variable inputs and hash functions according to an example. The operations of method 400 may be performed by a computing device, such as the computing device 700 depicted in FIG. 7. In some examples, certain operations depicted in method 400 may be combined, rearranged, or omitted.

At operation 402, a computing device receives a first hash configuration, such as hash configuration 202 depicted in FIG. 2. In some examples, the first hash configuration includes an indication of a first set of input types, such as an indication of the set of input types 204. Alternatively or additionally, the first hash configuration includes an indication of a first hash function, such as the indication of hash function 208. The indication of the first hash function may also include the first hash function itself. In some examples, the indication of the first hash function includes an index or pointer associated with the first hash function to enable the computing device to look up and/or identify the first hash function in a table or listing of multiple hash functions based on the index or pointer. In some examples, the first hash configuration includes an indication of a first input order (e.g., indication of input order 206) that indicates an order in which a first set of inputs (e.g., set of inputs 210 of FIG. 2B) corresponding to the first set of input types should be provided to the hash function. In some examples, the indication of the first input order is explicit, and is separate from the indication of the first set of input types. In some examples, the indication of the first input order is implicit within the indication of the first set of input types; e.g., the first input order is indicated by the order of the input types in the indication of the first input types.

At operation 404, the computing device detects a first request to change a user configuration setting (e.g., requesting to change the configuration data for a particular configuration item) associated with the computing device, wherein the first request comprises first configuration data (e.g., configuration data 104). For example, the computing device detects a user input in a user interface, such as in user interface 102 of FIG. 1, indicating a user selection of the first configuration data (e.g., selecting configuration data, such as “Browser 2,” to assign to the user configuration setting). In some examples, the computing device detects the request to change the user configuration setting via an OS user interface.

At operation 406, in response to detecting the first request to change the user configuration setting, the computer device generates, based on the first hash configuration and the first configuration data, a first verification code. For example, the computer device identifies, based on the first hash configuration, a first hashing function, a first set of inputs, and/or a first input order, and generates the first verification code by hashing, using the first hashing function, the first set of inputs in the first input order. The first set of inputs includes the first configuration data and any other inputs set forth in the hash configuration. For example, the set of inputs 210 shown in FIG. 2B includes the configuration data “Browser 2.”

At operation 408, the computing device stores (e.g., in a memory of the computing device, such as in a database containing configuration settings for the computing device) the first verification code generated at operation 406, such as described with reference to FIG. 2B.

At operation 410, after storing the first verification code, the computing device receives a second hash configuration. The second hash configuration may be different from the first hash configuration. In some examples, the computing device receives the second hash configuration as part of receiving an OS update or within another communication received by the computing device. In other examples, the computing device receives the second hash configuration in response to receiving a trigger that causes the computing device to retrieve the second hash configuration, such as if the second hash configuration is stored on the computing device. The second hash configuration includes an indication of a second set of input types, an indication of a second input order, and/or an indication of a second hash function.

At operation 412, after receiving the second hash configuration, the computing device detects a second request to change the user configuration setting associated with the computing device, wherein the second request comprises second configuration data. For example, the computing device detects a request to change the user configuration setting from the first configuration data received in the first request at operation 404 to the second configuration data, such as by detecting another user input in a user interface (e.g., user interface 102) indicating a user selection of the second configuration data.

At operation 414, in response to detecting the second request to change the user configuration setting, the computer device generates, based on the second hash configuration and the second configuration data, a second verification code. For example, the computer device identifies, based on the second hash configuration, a second hashing function, a second set of inputs, and/or a second input order, and generates the second verification code by hashing, using the second hashing function, the second set of inputs in the second input order. In some examples, the second set of inputs includes the second configuration data. If the second hash configuration excludes an indication of a second hash function, the computer device may generate the second verification code using the first hash function. If the second hash configuration data excludes an indication of a second set of input types, the computer device may generate the second verification code using a first set of inputs corresponding to the first set of input types. If the second hash configuration data excludes an indication of a second input order, the computer device may generate the second verification code using the first input order.

At operation 416, the computing device stores (e.g., in a memory of the computing device) the second verification code generated at operation 414. The computing device may store the second verification code with a second timestamp, such as a timestamp associated with the second request.

At operation 418, after storing the second verification code, the computing device detects a first event that is associated with the user configuration setting. For example, the computing device detects a request to open a file, a request to launch an application, a reboot of the computing device, or another event that causes the computing device to access configuration data associated with the user configuration setting.

At operation 420, in response to detecting the first event that is associated with the user configuration setting, the computing device retrieves third configuration data associated with the user configuration setting. For example, the computing device retrieves the third configuration data from a memory of the computing device.

At operation 422, the computing device generates a third verification code based on a current hash configuration (e.g., a most recently received hash configuration) and the third configuration data.

At 424, the computing device determines whether the third verification code matches the second verification code (e.g., the second verification code stored at operation 416),

In accordance with a determination that the third verification code matches the second verification code, the method 400 flows to operation 426. At operation 426, the computing device applies the third configuration data for the user configuration setting.

In accordance with a determination that the third verification code is different from the second verification code (e.g., the third verification code does not match the second verification code), the method 400 flows to operation 428. At operation 428, the computing device applies default configuration data for the user configuration setting; e.g., the computing device refrains from using the third configuration data for the user configuration setting. Alternatively or additionally to operation 428, the method 400 may perform operation 430 where a notification is generated and surfaced. The notification indicates that the configuration setting has been changed or altered. In some examples, the operation 430 may also include displaying an interface to allow the user to change the configuration setting.

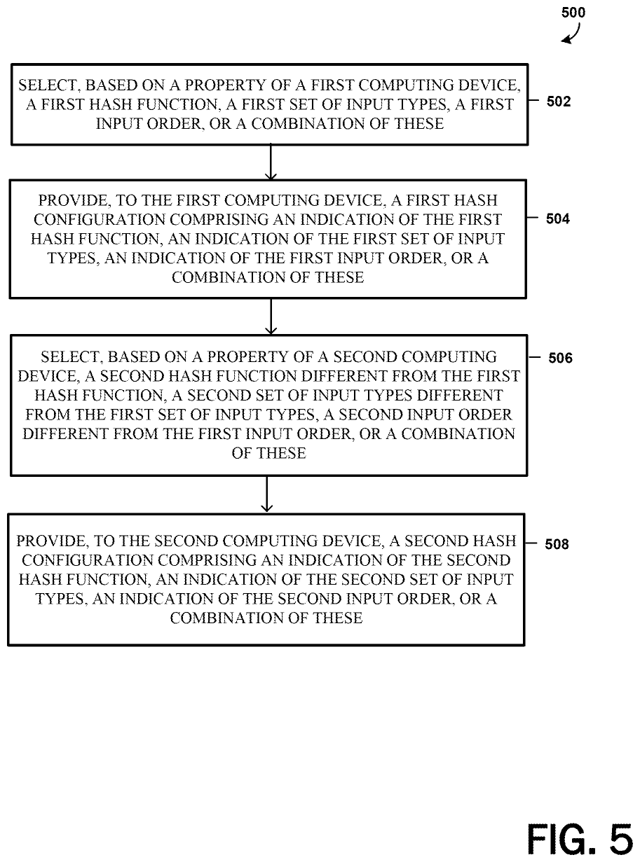

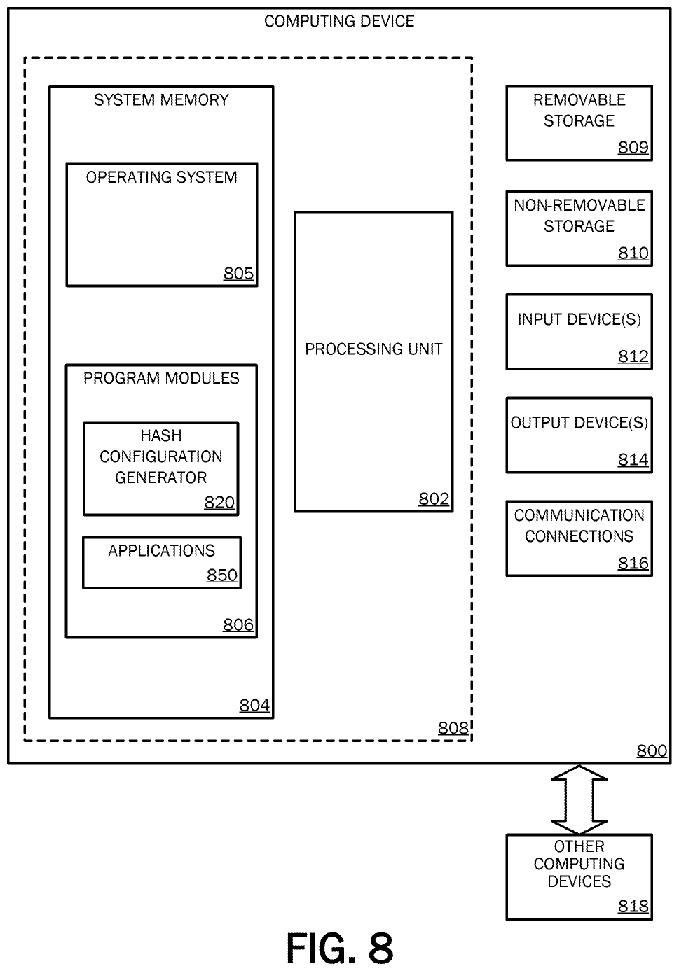

FIG. 5 depicts a flowchart of a method 500 for configuration verification using variable inputs and hash functions according to an example. The operations of method 500 may be performed by a computing system, such as computing device 800 depicted in FIG. 8 In some examples, certain operations depicted in method 500 may be combined, rearranged, or omitted.

At operation 502, the computing system selects, based on a first value of a property of a first computing device, a first hash configuration (e.g., such as hash configuration 202 of FIG. 2A) comprising an indication of a first hash function, an indication of a first set of input types, an indication of a first input order, or a combination of these. In some examples, the property of the first computing device includes some or all of a machine identifier associated with the first computing device (e.g., some or all of a serial number or other identifier, such as the last three digits) and/or a geographic location of the first computing device (e.g., a geographic location indicated by a postal code associated with the computing device, a country associated with the first computing device, a geographic region associated with the first computing device, a time zone associated with the first computing device, or another type of indicator).

At operation 504, the computing system provides, to the first computing device, the first hash configuration. In some examples, the computing system provides the first hash configuration to the first computing device by providing (e.g., transmitting) an update of an OS to the first computing device, where the OS update includes the first hash configuration. In some examples, the computing system provides the first hash configuration to the first computing device by transmitting the first hash configuration to the first computing device.

At operation 506, the computing system selects, based on a second value of a property of a second computing device, a second hash configuration different from the first hash configuration, the second hash configuration comprising an indication of a second hash function, an indication of a second set of input types, an indication of a second input order, or a combination of these. In some examples, the computing system selects the second hash configuration different from the first hash configuration based on the second value of the property (e.g., the value associated with the second computing device) being different from the first value of the property (e.g., the value associated with the first computing device). For example, the second computing device has a serial number with a different last three digits than the serial number of the first computing device, and/or the second computing device is located in a different zip code than the first computing device.

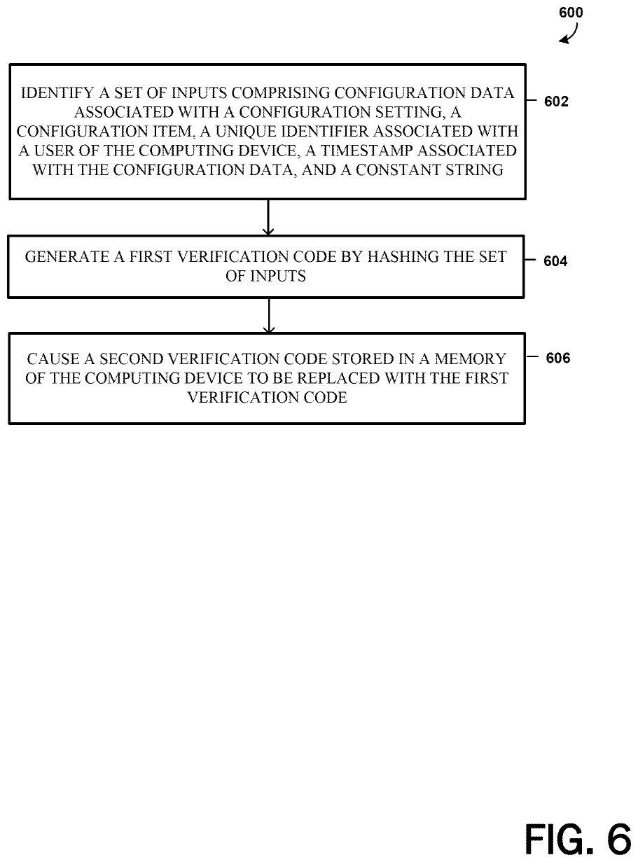

At operation 508, the computing system provides, to the second computing device, the second hash configuration, such as in the manner described with reference to operation 504. FIG. 6 depicts a flowchart of a method 600 for configuration verification using variable inputs and hash functions according to an example. The operations of method 600 may be performed by a computing device, such as the computing device 700 depicted in FIG. 7. In some examples, certain operations depicted in method 600 may be combined, rearranged, or omitted.

At operation 602, the computing device identifies a set of inputs that include configuration data associated with a configuration setting (e.g., “Browser 2” in FIG. 2), a configuration item (e.g., “http” or “Web Browser Default” in FIG. 2), a unique identifier associated with a user of the computing device (e.g., “Smith123” in FIG. 2), a timestamp associated with the configuration data (e.g., timestamp “03:21:01” in FIG. 2), and a constant string (e.g., constant string “Adarkandstormynight” in FIG. 2 or another GUID). The constant string may be provided as part of the hash configuration, and the constant string thus may change with updates or revisions to the hash configuration.

At operation 604, the computing device generates a first verification code by hashing the set of inputs (e.g., using a hash function) identified at operation 602.

At operation 606, the computing device causes a second verification code stored in a memory of the computing device (e.g., in a database that stores configuration information for the computing device) to be replaced with the first verification code generated at operation 604. For example, the computing device causes an operating system of the computing device to replace the second verification code with the first verification code by storing the first verification code in the memory of the computing device, such as in the database that stores configuration information for the computing device.

FIG. 7 and the associated description provides a discussion of a variety of operating environments in which examples of the disclosure may be practiced. However, the devices and systems illustrated and discussed with respect to FIG. 7 are for purposes of example and illustration; a vast number of computing device configurations may be utilized for practicing aspects of the disclosure described herein.

FIG. 7 is a block diagram illustrating physical components (e.g., hardware) of an example of a computing device 700 with which examples of the present disclosure may be practiced. The computing device components described below may be suitable for one or more of the components of the system 100 described above. In a basic configuration, the computing device 700 includes at least one processing unit 702 (e.g., at least one processor) and a system memory 704. Depending on the configuration and type of computing device 700, the system memory 704 may comprise volatile storage (e.g., random access memory), non-volatile storage (e.g., read-only memory), flash memory, or any combination of such memories. In the example of FIG. 7, the system memory 704 includes an operating system 705 and program modules 706 for performing various functionalities, including applications 705. In the example of FIG. 7, the operating system 705 includes instructions for implementing a verification code generator 720 (e.g., for generating verification codes as described with reference to FIGS. 1-4B) and a configuration data verifier 722 (e.g., for verifying configuration data using a verification code, as described with reference to FIG. 2B). In other examples, the verification code generator 720 resides in an application 705 (e.g., if the verification code generation is performed by software that is different from the operating system, such as if a third-party vendor performs verification code generation). In some examples, the computing device 700 includes the verification code generator 720 and excludes the configuration data verifier 722.

The operating system 705 may be suitable for controlling the operation of the computing device 700, such as scheduling tasks, controlling peripheral devices, and managing other aspects of software, hardware, and input/output (I/O) on the computing device 700.

Aspects of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 and/or operating system 705 may perform processes including one or more of the stages of the methods 400 and 600 illustrated in FIGS. 4A-4B and FIG. 6. In some examples, such processes and methods may be distributed across multiple processing units 702, such that each processing unit 702 performs a portion of the processes and methods.

Furthermore, examples of the disclosure may be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing spatial-textual clustering-based predictive recognition of text in a video may be operated via application-specific logic integrated with other components of the computing device 700 on the single integrated circuit (chip). Examples of the present disclosure may also be practiced using other technologies capable of performing logical operations such as, for example, AND, OR, and NOT, including mechanical, optical, fluidic, and quantum technologies.

In the example of FIG. 7, the computing device 700 also has one or more input device(s) 712 (such as a keyboard, a mouse, a pen, a sound input device, a touch input device, a camera, etc.) and output device(s) 714 (such as a display, speakers, a printer, etc.). The aforementioned devices are examples and others may be used. In some examples, the computing device 700 omits the input device(s) 712 and/or output devices 714. In the example of FIG. 7, the computing device 700 includes one or more communication connections 716 to enable communications with other computing devices 718. Examples of communication connections 716 include an RF transmitter, receiver, and/or transceiver circuitry; universal serial bus (USB), parallel, and/or serial ports.

FIG. 8 and the associated description provides a discussion of a variety of operating environments in which examples of the disclosure may be practiced. However, the devices and systems illustrated and discussed with respect to FIG. 8 are for purposes of example and illustration; a vast number of computing device configurations may be utilized for practicing aspects of the disclosure described herein.

FIG. 8 is a block diagram illustrating physical components (e.g., hardware) of an example of a computing device 800 with which examples of the present disclosure may be practiced. The computing device components described below may be suitable for one or more of the components of the system 100 described above. In a basic configuration, the computing device 800 includes at least one processing unit 802 (e.g., at least one processor) and a system memory 804. Depending on the configuration and type of computing device 800, the system memory 804 may include volatile storage (e.g., random access memory), non-volatile storage (e.g., read-only memory), flash memory, or any combination of such memories. In the example of FIG. 8, the system memory 804 includes an operating system 805 and program modules 806 for performing various functionalities, including applications 805. The operating system 805 may be suitable for controlling the operation of the computing device 800, such as scheduling tasks, controlling peripheral devices, and managing other aspects of software, hardware, and input/output (I/O) on the computing device 800.

Aspects of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. In the example of FIG. 8, the program modules include a hash configuration generator 820 for generating hash configurations (e.g., hash configurations that may be included in an OS update or other transmission provided to other computing devices). While executing on the processing unit 802, the program modules 806 may perform processes including one or more of the stages of the method 500 illustrated in FIG. 5. In some examples, such processes and methods may be distributed across multiple processing units 802, such that each processing unit 802 performs a portion of the processes and methods.

Examples of the disclosure may be practiced via an SOC where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing spatial-textual clustering-based predictive recognition of text in a video may be operated via application-specific logic integrated with other components of the computing device 800 on the single integrated circuit (chip). Examples of the present disclosure may also be practiced using other technologies capable of performing logical operations such as, for example, AND, OR, and NOT, including mechanical, optical, fluidic, and quantum technologies.

In the example of FIG. 8, the computing device 800 also has one or more input device(s) 812 (such as a keyboard, a mouse, a pen, a sound input device, a touch input device, a camera, etc.) and output device(s) 814 (such as a display, speakers, a printer, etc.). The aforementioned devices are examples and others may be used. In some examples, the computing device 800 omits the input device(s) 812 and/or output devices 814. In the example of FIG. 8, the computing device 800 includes one or more communication connections 816 to enable communications with other computing devices 818, such as to transmit hash configurations to other computing devices 818. Examples of communication connections 816 include an RF transmitter, receiver, and/or transceiver circuitry; universal serial bus (USB), parallel, and/or serial ports.

The term computer readable media as used herein includes volatile and nonvolatile, removable and non-removable media implemented in any method or technology for storage of information, such as computer readable instructions, data structures, or program modules. The system memories 704 and 804, the removable storage devices 709 and 809, and the non-removable storage devices 710 and 810 of FIGS. 7 and 8 are all computer readable media examples (e.g., memory storage.) Computer readable media include random access memory (RAM), read-only memory (ROM), electrically erasable programmable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700 and/or computing device 800. Any such computer readable media may be part of the computing device 700 and/or computing device 800. In some examples, computer readable media includes non-transitory computer readable media and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

In an aspect, the technology relates to a computing device for verifying user-selected configuration settings. The computing device includes at least one processor; and memory storing instructions that, when executed individually or collectively by the at least one processor, cause the computing device to perform operations. The operations include receiving a first hash configuration; receiving a first request to change a user configuration setting associated with the computing device, wherein the first request includes first configuration data; in response to receiving the first request to change the user configuration setting, generating, based on the first hash configuration and the first configuration data, a first verification code; storing the first verification code; after storing the first verification code, receiving a second hash configuration; after receiving the second hash configuration, receiving a second request to change the user configuration setting, wherein the second request includes second configuration data different from the first configuration data; in response to receiving the second request, generating, based on the second hash configuration and the second configuration data, a second verification code; and storing the second verification code.

In an example, the first hash configuration includes an indication of a first hash function, and generating the first verification code includes hashing, using the first hash function, a first set of inputs in a first input order, wherein the first set of inputs includes the first configuration data. In a further example, the first hash configuration includes an indication of a first set of input types, and generating the first verification code includes obtaining the first set of inputs based on the indication of the first set of input types. In yet another example, the first hash configuration includes an indication of the first input order. In still another example, the first set of inputs includes a machine identifier associated with the computing device, a user identifier associated with the computing device, a timestamp associated with the first request to change the user configuration setting, a constant string, or a combination of these. In still yet another example, generating the second verification code based on the second hash configuration includes hashing, using a second hash function, a second set of inputs in a second input order.

In a further example, the second hash configuration includes an indication of a second set of input types, and generating the second verification code includes obtaining the second set of inputs based on the indication of the second set of input types. In a still further example, the first set of input types includes a first quantity of input types and the second set of input types includes a second quantity of input types, the second quantity different from the first quantity. In another example, the first set of input types is the same as the second set of input types and the first input order is different from the second input order. In still another example, the first set of input includes a first timestamp associated with the first request and the second set of inputs includes a second timestamp associated with the second request, the method further including: storing the first timestamp with the first configuration data; and storing the second timestamp with the second configuration data. In yet another example, the operations further include after storing the second verification code, receiving a third hash configuration, wherein the third hash configuration includes an indication of a third set of input types, an indication of a third input order, an indication of a third hash function, or a combination of these; in response to receiving the third hash configuration, generating, based on the third hash configuration, a third verification code associated with the second configuration data; and storing the third verification code.

In another example, the operations further include after storing the second verification code, detecting a first event that is associated with the user configuration setting; in response to detecting the first event that is associated with the user configuration setting: retrieving third configuration data associated with the user configuration setting; generating a third verification code based on a current hash configuration and the third configuration data; determining that the third verification code is different from the second verification code; and in accordance with the determination that the third verification code is different from the second verification code, applying default configuration data for the user configuration setting. In still another example, the operations further include detecting a second event that is associated with the user configuration setting; in response to detecting the second event that is associated with the user configuration setting: retrieving fourth configuration data associated with the user configuration setting; generating a fourth verification code based on the current hash configuration and the fourth configuration data; determining that the fourth verification code matches the second verification code; and in accordance with the determination that the fourth verification code matches the second verification code, applying the fourth configuration data for the user configuration setting.

In another aspect, the technology relates to a computer-implemented method. The method includes selecting, based on a property of a first computing device, a first hash configuration including a first hash function, a first set of input types, a first input order, or a combination of these; providing, to the first computing device, the first hash configuration; selecting, based on a property of a second computing device, a second hash configuration different from the first hash configuration, wherein the second hash configuration includes a second hash function different from the first hash function, a second set of input types different from the first set of input types, a second input order different from the first input order, or a combination of these; and providing, to the second computing device, the second hash configuration.

In an example, the property of the first computing device includes at least a portion of a first machine identifier associated with the first computing device or a first geographic location associated with the first computing device, and the property of the second computing device includes at least a portion of a second machine identifier associated with the second computing device or a second geographic location associated with the second computing device. In another example, the first set of input types includes input types corresponding to: configuration data associated with a configuration setting of the first computing device, a machine identifier associated with the first computing device, a user identifier associated with the first computing device, a timestamp associated with a request to change the configuration setting, a constant string. In still another example, the first set of input types includes a first quantity of input types and the second set of input types includes a second quantity of input types different from the first quantity of input types. In still yet another example, providing, to the first computing device, the first hash configuration includes transmitting, to the first computing device, an update of an operating system.

In another aspect, the technology relates to a method performed at a computing device. The method includes identifying a set of inputs including configuration data associated with a configuration setting, a configuration item, a unique identifier associated with a user of the computing device, a timestamp associated with the configuration data, and a constant string; generating a first verification code by hashing the set of inputs; and causing a second verification code stored in a memory of the computing device to be replaced with the first verification code.

In an example, the method further includes identifying an input order associated with the set of inputs, wherein the set of inputs are hashed in the input order.

It is to be understood that the methods, modules, and components depicted herein are merely examples. Alternatively, or in addition, the functionality described herein can be performed, at least in part, by one or more hardware logic components. For example, illustrative types of hardware logic components that can be used include Field-Programmable Gate Arrays (FPGAs), Application-Specific Integrated Circuits (ASICs), Application-Specific Standard Products (ASSPs), System-on-a-Chip systems (SOCs), Complex Programmable Logic Devices (CPLDs), etc.

The functionality associated with some examples described in this disclosure can also include instructions stored in a non-transitory media. The term “non-transitory media” as used herein refers to any media storing data and/or instructions that cause a machine to operate in a specific manner. Illustrative non-transitory media include non-volatile media and/or volatile media. Non-volatile media include, for example, a hard disk, a solid-state drive, a magnetic disk or tape, an optical disk or tape, a flash memory, an EPROM, NVRAM, PRAM, or other such media, or networked versions of such media. Volatile media include, for example, dynamic memory such as DRAM, SRAM, a cache, or other such media. Non-transitory media is distinct from, but can be used in conjunction with transmission media. Transmission media is used for transferring data and/or instruction to or from a machine. Examples of transmission media include coaxial cables, fiber-optic cables, copper wires, and wireless media, such as radio waves.

Furthermore, those skilled in the art will recognize that boundaries between the functionality of the above-described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure provides specific examples, various modifications and changes can be made without departing from the scope of the disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to a specific example are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A computing device for verifying user-selected configuration settings, the computing device comprising:
at least one processor; and
memory storing instructions that, when executed individually or collectively by the at least one processor, cause the computing device to perform operations comprising:
receiving a first hash configuration;
receiving a first request to change a user configuration setting associated with the computing device, wherein the first request comprises first configuration data;
in response to receiving the first request to change the user configuration setting, generating, based on the first hash configuration and the first configuration data, a first verification code;
storing the first verification code;
after storing the first verification code, receiving a second hash configuration;
after receiving the second hash configuration, receiving a second request to change the user configuration setting, wherein the second request comprises second configuration data different from the first configuration data;
in response to receiving the second request, generating, based on the second hash configuration and the second configuration data, a second verification code; and
storing the second verification code.

2. The computing device of claim 1, wherein the first hash configuration comprises an indication of a first hash function, and generating the first verification code comprises:
hashing, using the first hash function, a first set of inputs in a first input order, wherein the first set of inputs comprises the first configuration data.

3. The computing device of claim 2, wherein the first hash configuration comprises an indication of a first set of input types, and generating the first verification code comprises:
obtaining the first set of inputs based on the indication of the first set of input types.

4. The computing device of claim 2, wherein the first hash configuration comprises an indication of the first input order.

5. The computing device of claim 2, wherein the first set of inputs comprises a machine identifier associated with the computing device, a user identifier associated with the computing device, a timestamp associated with the first request to change the user configuration setting, a constant string, or a combination of these.

6. The computing device of claim 2, wherein generating the second verification code based on the second hash configuration comprises:
hashing, using a second hash function, a second set of inputs in a second input order.

7. The computing device of claim 6, wherein the second hash configuration comprises an indication of a second set of input types, and generating the second verification code comprises:
obtaining the second set of inputs based on the indication of the second set of input types.

8. The computing device of claim 7, wherein the first set of input types comprises a first quantity of input types and the second set of input types comprises a second quantity of input types, the second quantity different from the first quantity.

9. The computing device of claim 7, wherein the first set of input types is the same as the second set of input types and the first input order is different from the second input order.

10. The computing device of claim 2, wherein the first set of input comprises a first timestamp associated with the first request and the second set of inputs comprises a second timestamp associated with the second request, the method further comprising:
storing the first timestamp with the first configuration data; and
storing the second timestamp with the second configuration data.

11. The computing device of claim 1, wherein the operations further comprise:
after storing the second verification code, receiving a third hash configuration, wherein the third hash configuration comprises an indication of a third set of input types, an indication of a third input order, an indication of a third hash function, or a combination of these;
in response to receiving the third hash configuration, generating, based on the third hash configuration, a third verification code associated with the second configuration data; and
storing the third verification code.

12. The computing device of claim 1, wherein the operations further comprise:
after storing the second verification code, detecting a first event that is associated with the user configuration setting;
in response to detecting the first event that is associated with the user configuration setting:
retrieving third configuration data associated with the user configuration setting;
generating a third verification code based on a current hash configuration and the third configuration data;
determining that the third verification code is different from the second verification code; and
in accordance with the determination that the third verification code is different from the second verification code, applying default configuration data for the user configuration setting.

13. The computing device of claim 12, wherein the operations further comprise:
detecting a second event that is associated with the user configuration setting;
in response to detecting the second event that is associated with the user configuration setting:
retrieving fourth configuration data associated with the user configuration setting;
generating a fourth verification code based on the current hash configuration and the fourth configuration data;
determining that the fourth verification code matches the second verification code; and
in accordance with the determination that the fourth verification code matches the second verification code, applying the fourth configuration data for the user configuration setting.

14. A computer-implemented method, comprising:
selecting, based on a property of a first computing device, a first hash configuration comprising a first hash function, a first set of input types, a first input order, or a combination of these;
providing, to the first computing device, the first hash configuration;
selecting, based on a property of a second computing device, a second hash configuration different from the first hash configuration, wherein the second hash configuration comprises a second hash function different from the first hash function, a second set of input types different from the first set of input types, a second input order different from the first input order, or a combination of these; and
providing, to the second computing device, the second hash configuration.

15. The computer-implemented method of claim 14, wherein the property of the first computing device comprises at least a portion of a first machine identifier associated with the first computing device or a first geographic location associated with the first computing device, and the property of the second computing device comprises at least a portion of a second machine identifier associated with the second computing device or a second geographic location associated with the second computing device.

16. The computer-implemented method of claim 14, wherein the first set of input types comprises input types corresponding to: configuration data associated with a configuration setting of the first computing device, a machine identifier associated with the first computing device, a user identifier associated with the first computing device, a timestamp associated with a request to change the configuration setting, a constant string.

17. The computer-implemented method of claim 14, wherein the first set of input types comprises a first quantity of input types and the second set of input types comprises a second quantity of input types different from the first quantity of input types.

18. The computer-implemented method of claim 14, wherein providing, to the first computing device, the first hash configuration comprises transmitting, to the first computing device, an update of an operating system.

19. A method performed at a computing device, the method comprising:
identifying a set of inputs comprising configuration data associated with a configuration setting, a configuration item, a unique identifier associated with a user of the computing device, a timestamp associated with the configuration data, and a constant string;
generating a first verification code by hashing the set of inputs; and
causing a second verification code stored in a memory of the computing device to be replaced with the first verification code.

20. The method of claim 19, further comprising:
identifying an input order associated with the set of inputs, wherein the set of inputs are hashed in the input order.
